(19) United States
(12) Patent Application Publication
(10) Pub. No.: US 2008/0172340 A1
(43) Pub. Date: Jul. 17, 2008

(54) METHOD AND SYSTEM FOR CARRYING OUT A TRANSACTION BETWEEN A MOBILE DEVICE AND A TERMINAL

(76) Inventor: Thomas Karlsson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/623,106

(22) Filed: Jan. 15, 2007

(51) Int. Cl. H04K 1/00

(52) U.S. Cl. 705/75

(57) ABSTRACT

A method of conducting a transaction between a user of a mobile electronic device and a vendor includes determining a location of the mobile electronic device. At least one transaction terminal that has a location-based relationship with the mobile electronic device is identified. A transaction code for authenticating the mobile electronic device during interaction of the mobile electronic device and the transaction terminal is provided to the identified transaction terminal and the mobile electronic device.

### TECHNICAL FIELD OF THE INVENTION

The present invention relates generally to transactional activity and, more particularly, to a system and method for carrying out a transaction between a mobile device and a terminal.

### DESCRIPTION OF THE RELATED ART

Debit cards, credit cards and smart cards are convenient ways to pay for many purchases. Similarly, interaction with an automated teller machine (ATM) using an ATM card, debit card, credit card or smart card is a convenient way to withdraw cash from a banking account. However, if one these cards or the data from one of these cards falls into unscrupulous hands, fraudulent charges or withdrawals may be made.

Various security measures have been attempted in connection with the use of the above-mentioned cards. For instance, personal identification number (PIN) codes, card security codes (CSC) and card verification values (CVV) have been employed to reduce the occurrence of fraudulent transactions. Unfortunately, fraudulent transactions continue to occur.

### SUMMARY

To enhance the security relating to purchase transactions and automated banking transactions, there is a need in the art for improved systems and methods for carrying out these types of transactions. Portable electronic devices, such as mobile telephones, now have widespread use. An improved system and method for carrying out purchase and banking transactions may take advantage of the network and/or localized communication capabilities of mobile telephone or similar devices to improve the security associated with such transactions. Also, the improved system and method reduces the reliance on carrying card-based payment and banking items, thereby reducing the number of items that a person may find that he or she needs to carry.

According to one aspect of the invention, a method of conducting a transaction includes determining a location of a mobile electronic device; identifying at least one transaction terminal that has a location-based relationship with the mobile electronic device; and providing a transaction code to the identified transaction terminal and the mobile electronic device, the transaction code for authenticating the mobile electronic device during interaction of the mobile electronic device and the transaction terminal.

According to an embodiment of the method, the transaction code is valid for a limited duration.

According to an embodiment of the method, the transaction code is valid for a single transaction.

According to an embodiment of the method, location data for the mobile electronic device is supplied by one of the mobile electronic device or a communications network that supplies communications services to the mobile electronic device.

According to an embodiment of the method, the identified transaction terminal is within a predetermined distance from the location of the mobile electronic.

According to an embodiment of the method, the identified transaction terminal is selected by a user of the mobile electronic device.

According to one embodiment, the method further includes receiving a transaction parameter from the mobile electronic device and authorizing the transaction.

According to one embodiment, the method further includes transmitting the transaction parameter to the transaction terminal.

According to an embodiment of the method, the transaction is a withdrawal of money from a bank account or a cash advance.

According to an embodiment of the method, the transaction terminal is an automated teller machine.

According to an embodiment of the method, the transaction is the purchase of at least one of goods or services.

According to an embodiment of the method, the transaction terminal is a vending machine.

According to an embodiment of the method, the transaction terminal is a cash register.

According to another aspect of the invention, a method of conducting a transaction includes transmitting a transaction request from a mobile electronic device to a transaction server; receiving a transaction code from the transaction server with the mobile electronic device, the transaction code for authenticating the mobile electronic device during interaction of the mobile electronic device and a transaction terminal; establishing a communication link between the mobile electronic device and the transaction terminal; and transmitting the transaction code to the transaction terminal.

According to an embodiment of the method, the transaction code is valid for a limited duration.

According to an embodiment of the method, the transaction code is valid for a single transaction.

According to one embodiment, the method further includes providing a location of the mobile electronic device to the transaction server.

According to one embodiment, the method further includes transmitting a transaction parameter to the transaction server.

According to yet another aspect of the invention, a method of conducting a transaction includes receiving a transaction code from a transaction server with a transaction terminal, the transaction code for authenticating a mobile electronic device during interaction of the mobile electronic device and the transaction terminal; establishing a communication link between the transaction terminal and the mobile electronic device; receiving a transaction code from the mobile electronic device; and verifying that the transaction code from the mobile electronic device matches the transaction code from the transaction server.

According to an embodiment of the method, the transaction codes are valid for a limited duration and the method further includes verifying that the transaction codes have not expired.

According to an embodiment of the method, the transaction codes are valid for a single transaction.

According to one embodiment, the method further includes requesting additional authentication from the user of the mobile electronic device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device for use in a transaction system in accordance with embodiments of the present invention;

FIG. 2 is a schematic block diagram of the relevant portions of the mobile telephone of FIG. 1;

FIG. 3 is a schematic diagram of an exemplary transaction system in which the mobile telephone of FIG. 1 may operate;

FIG. 4 is a schematic block diagram of a transaction terminal for use in the transaction system of FIG. 3;

FIG. 5 is a diagram showing an exemplary transaction scheme carried out by components of the transaction system in accordance with an embodiment of the present invention; and

FIG. 6 is a flow chart representing an exemplary method of processing a transaction with the transaction terminal of FIG. 4.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of carrying out a transaction using a mobile telephone. However, it will be appreciated that the invention is not intended to be limited to the context of a mobile telephone and may relate to any type of appropriate electronic equipment, examples of which include a media player, a gaming device and a computer.

A transaction, as used herein, is any monetary or non-monetary based proceeding between two parties. One exemplary transaction is the withdrawal of funds from a bank account using an automated teller machine (ATM). Another exemplary transaction is the payment for goods and/or services from a vendor. The vendor may be a conventional store with human employees or an automated vendor, such as a vending machine. The two parties will be referred to herein as the user and the provider. The provider in the foregoing examples is the bank and the vendor, respectively. Intermediary parties that may be involved in the transaction include a communications service provider associated with the user's electronic equipment and/or a transaction service provider associated with the provider. As will be appreciated, the actions of the end parties and/or the intermediary parties need not be carried out by a person, but may involve completely automated steps or a mixture of automated and manual steps.

As will be explained in greater detail below, an exemplary system for executing a transaction includes an electronic device belonging to or in the possession the user and a terminal associated with the vendor.

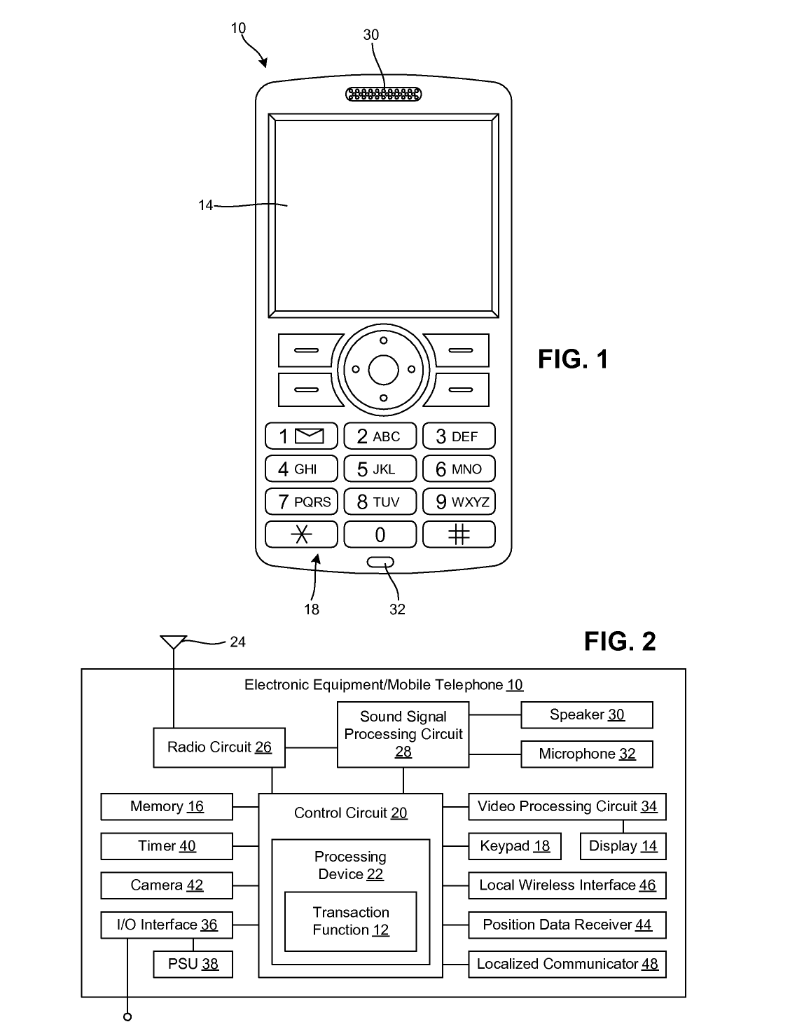

Referring initially to FIGS. 1 and 2, an electronic device 10 is shown. The electronic device 10 includes a transaction function 12 that is configured to facilitate a transaction between the user and the vendor. Additional details and operation of the transaction function 12 will be described in greater detail below. The transaction function 12 may be embodied as executable code that is resident in and executed by the electronic device 10. In one embodiment, the transaction function 12 may be a program stored on a computer or machine readable medium. The transaction function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other type housings, such as a “flip-open” form factor (e.g., a clamshell housing) or a slide-type housing, may be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi, WiMax, etc. Another example includes a video enabled call that is established over a cellular or alternative network.

The mobile telephone 10 may be configured to transmit, receive and/or process data, such as text messages (e.g., colloquially referred to by some as “an SMS,” which stands for simple message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory or other suitable device.

In addition, the processing device 22 may execute code that implements the transaction function 12. It will be apparent to a person having ordinary skill in the art of computer programming, and specifically in application programming for mobile telephones or other electronic devices, how to program a mobile telephone 10 to operate and carry out logical functions associated with the transaction function 12. Accordingly, details as to specific programming code have been left out for the sake of brevity. Also, while the transaction function 12 is executed by the processing devices in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream received by the radio circuit 28 or obtained by any other suitable method.

The mobile telephone 10 may further include one or more I/O interface(s) 36. The IO interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a timer 40 for carrying out timing functions. Such functions may include timing the durations of calls, generating the content of time and date stamps, etc.

The mobile telephone 10 may include a camera 42 for taking digital pictures and/or movies. Image and/or video files corresponding to the pictures and/or movies may be stored in the memory 16.

The mobile telephone 10 also may include a position data receiver 44, such as a global positioning system (GPS) receiver, Galileo satellite system receiver or the like. The current location of the mobile telephone 10 may be determined using any appropriate positioning technology, including assisted GPS (AGPS) that uses an assistance server (e.g., a mobile location server or MLS) to assist the position data receiver in performing tasks to make range measurements and position solutions. GPS coordinates may be expressed using a standard reference system, such as the world geodetic system (WGS). In another approach, the location determination mechanism may include accessing an identity of a communications access point (e.g., communications tower) servicing the mobile telephone 10. In one embodiment, the communications tower may be part of a cellular network (e.g., a “cell” tower) that has an associated identifier (e.g., “cell ID”) and the identifier is communicated as an identifier or position. Each identifier or cell ID in a particular servicing network may be assumed to be unique and, therefore, may be used to indicate relative proximity to a certain location. In one embodiment, the cell ID and any related radio parameters may be used to generate a coordinate value through a radio network service. For example, under global system mobile communications (GSM) and universal mobile telecommunications system (UMTS) protocols, the position could be estimated through a mobile originated location request (MO-LR) to the network so that the mobile telephone 10 position could be estimated using the network's knowledge of tower locations and antenna directions.

The mobile telephone 10 also may include a local wireless interface 46, such as an infrared transceiver and/or an RF adaptor (e.g., a Bluetooth adapter, a WiFi adapter compatible with IEEE standard 802.11, a WiMax adapter compatible with IEEE standard 802.16, etc.), for establishing wireless communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface. Also, as described below, the local wireless interface 46 may be used to establish communication with a terminal associated with a vendor.

The mobile telephone 10 also may include a localized communicator 48 to establish a localized communication link with a compatible component of another device when the devices are brought in relatively close proximity to each other. The localized communicator 48 may be, for example, a near field communication (NFC) chipset or comparable communication component. The term NFC is generally used to refer to a magnetic field induction communication interface and protocol that was jointly developed by Sony and Phillips and which has been adopted as standards by ECMA (ECMA-340) and ISO/IEC (ISO/IEC 18092). NFC generally has a working distance of about zero centimeters to about twenty centimeters. NFC may be used in a passive communication mode where an initiator device provides a carrier field and that is answered by modulating the existing field with a transponder, which may draw operating power from the initiator-provided electromagnetic field. NFC also may be used in an active communication mode where both the initiator and transponder communicate by generating their own fields, in which case both the initiator and the transponder typically receive power from a power supply. NFC may be used to configure and initiate another wireless network connection between devices, such as Bluetooth, WiFi and WiMax connections. As will be appreciated, the description of an NFC chipset is meant to be an example of a close-proximity communication technique and any appropriate device or technique to establish a localized communication link may be used. Exemplary approaches to close-proximity communications may rely on a capacitive coupling technique, a propagating wave (e.g., electromagnetic) technique, a radio frequency transmission technique, a magnetic field induction technique or any other appropriate technique. These techniques are often used for RF identification (RFID) devices and will be understood by those of ordinary skill in the art.

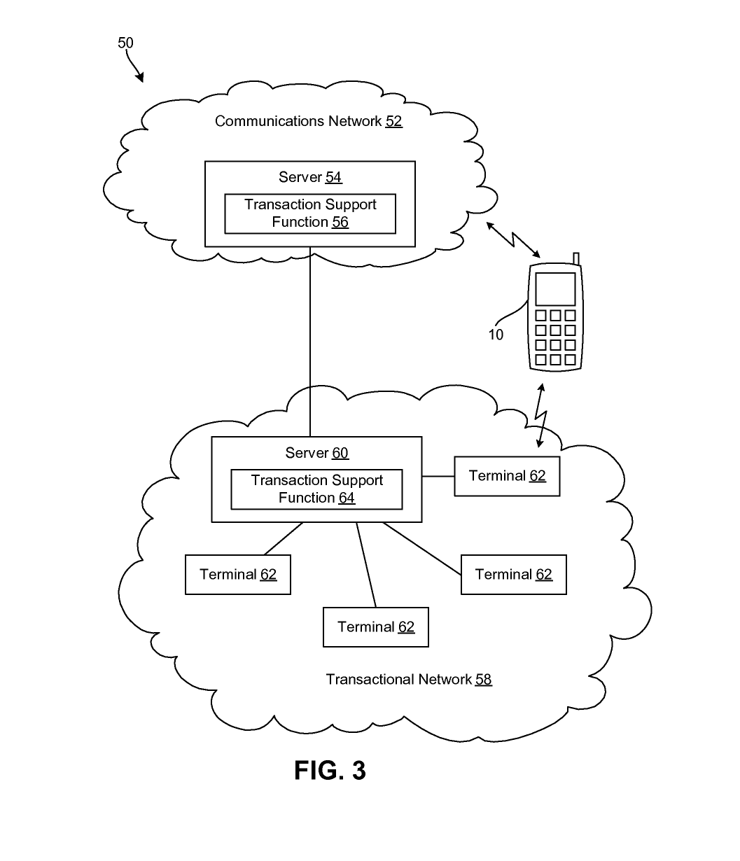

With additional reference to FIG. 3, the mobile telephone 10 may be configured to operate as part of a transactional system 50. The system 50 may include a communications network 52 that services the mobile telephone 10 by providing call and data support. The communications network 52 may have a server 54 (or servers) for managing calls placed by and destined to the mobile telephone 10, transmitting data to the mobile telephone 10 and carrying out any other support functions. The server 54 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 52 may support the communications activity of multiple mobile telephones 10 and other types of end user devices.

As will be appreciated, the server 54 may be configured as a typical computer system used to carry out server functions and may include a processor configured to execute software containing logical instructions that embody the functions of the server 54 and a memory to store such software. In one embodiment, the server 54 may be configured to store and execute a transaction support function 56 that interacts with the transaction function 12 of the mobile telephone 10. In one embodiment, the transaction support function 56 may be a program stored on a computer or machine readable medium. The transaction support function 56 may be a stand-alone software application or may form a part of a software application that carries out additional tasks related to the functions of the server 54. In one embodiment, the functions of the transaction support function 56 may be distributed among multiple servers, including one or more servers located outside the domain of the communications network 52.

The transactional system 50 also may include a transactional network 58 that includes a server 60 (or servers) for managing transactions to which the vendor is a party. The transaction network 58 may further include one or more terminals 62 that communicate with the server 60. The server 60 may communicate with the communications network server 54 so that data may be exchanged between the mobile telephone 10 and the transactional network server 60 via the communications network 52.

As will be appreciated, the server 60 may be configured as a typical computer system used to carry out server functions and may include a processor configured to execute software containing logical instructions that embody the functions of the server 60 and a memory to store such software. In one embodiment, the server 60 may be configured to store and execute a transaction support function 64 that interacts with the terminals 62 and the mobile telephone 10 via the communications network 52. In one embodiment, the transaction support function 64 may be a program stored on a computer or machine readable medium. The transaction support function 64 may be a stand-alone software application or may form a part of a software application that carries out additional tasks related to the functions of the server 60. In one embodiment, the functions of the transaction support function 64 may be distributed among multiple servers, including one or more servers located outside the domain of the transactional network 58.

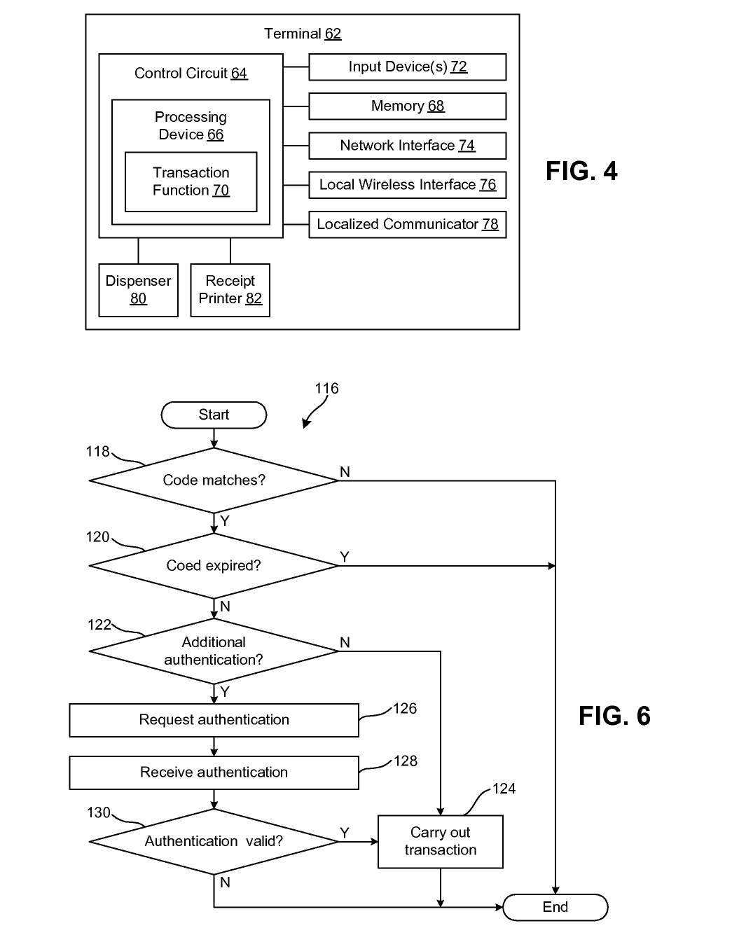

With additional reference to FIG. 4, a schematic block diagram of an exemplary one of the terminals 62 is illustrated. The terminal 62 may include a primary control circuit 64 that is configured to carry out overall control of the functions and operations of the terminal 62. The control circuit 64 may include a processing device 66, such as a CPU, microcontroller or microprocessor. The processing device 66 executes code stored in a memory (not shown) within the control circuit 64 and/or in a separate memory, such as a memory 68, in order to carry out operation of the terminal 62. The memory 68 may be, for example, one or more of a buffer, a flash memory, a hard drive, a removable media, a volatile memory, a non-volatile memory or other suitable device.

Among the applications executed by the processing device 66 may be a transaction function 70. Additional details and operation of the transaction function 70 will be described in greater detail below. The transaction function 70 may be embodied as executable code that is resident in and executed by the terminal 62. In one embodiment, the transaction function 70 may be a program stored on a computer or machine readable medium. The transaction function 70 may be a stand-alone software application or form a part of a software application that carries out additional tasks related to the terminal 70.

The terminal 62 may include one or more user input devices 72, such as a keypad for accepting entry of alphanumeric data. The input devices 72 may include a biometric scanner, such as a finger print reader or a retinal scanner.

The terminal 62 may include a network interface 74 to establish a communications link with the server 60. Also, the terminal 62 may include an interface device to communicate with the mobile telephone 10 when the mobile telephone 10 is in relatively close proximity to the terminal 62 (e.g., about 30 meters or less). For instance, the terminal 62 may include a local wireless interface 76 that is compatible with the local wireless interface 46 of the mobile telephone 46. Exemplary local wireless interfaces include an infrared transceiver and an RF adaptor (e.g., a Bluetooth adapter, a WiFi adapter compatible with IEEE standard 802.11, a WiMax adapter compatible with IEEE standard 802.16, etc.). In addition to or instead of the local wireless interface 76, the terminal 62 may include a localized communicator 78 that is compatible with the localized communicator 48 of the mobile telephone 10, such as an NFC chipset, RFID reader and so forth. Multiple local wireless interfaces 76 and/or localized communicators 78 may be present to enable communications with a plurality of types of user devices that may have diverse types of local wireless interfaces and/or localized communicators.

The terminal 62 may include a dispenser 80. For instance, the dispenser 80 may be a currency (e.g., cash) dispenser in embodiments where the terminal 62 is configured as an ATM. In another example, the dispenser may dispense food, beverages or non-consumable goods in embodiments where the terminal 62 is configured as a vending machine. In other embodiment, the terminal 62 may be a cash register for a store and the dispenser 80 may be omitted. The terminal 62 may include a printer 82 to generate a receipt corresponding to a transaction that involved use of the terminal 62.

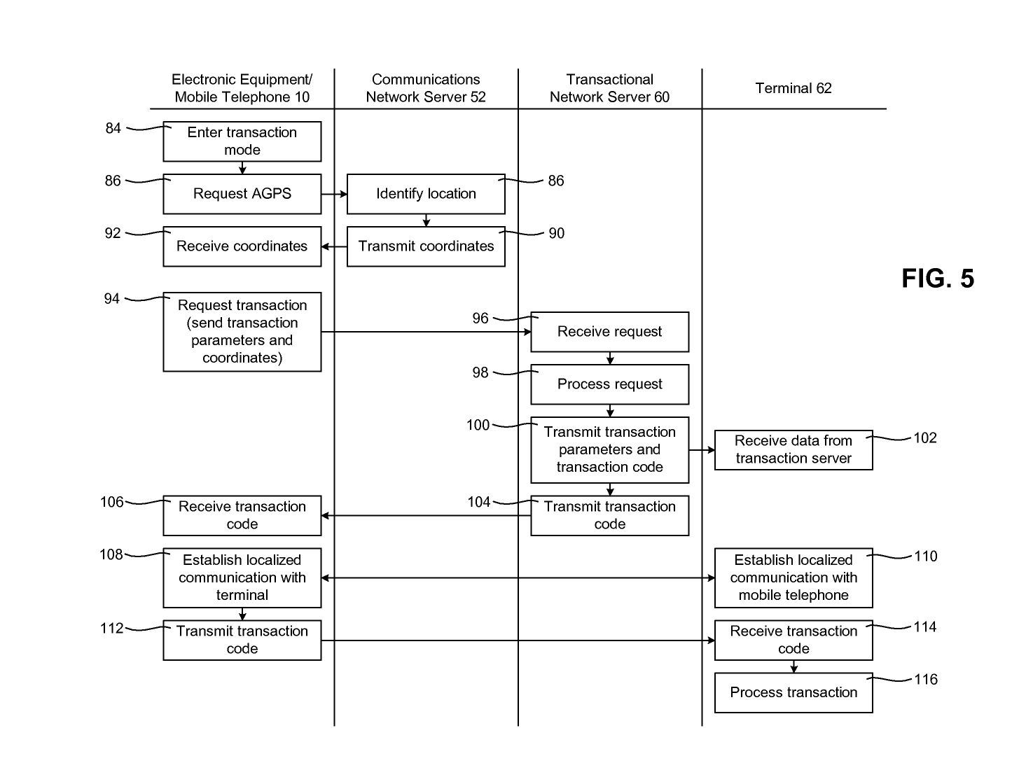

With additional reference to FIG. 5, illustrated are logical operations and interactions carried out by the various components of the transaction system 50 to implement an exemplary method of conducting a transaction between two parties. The exemplary method may be carried out by or may include executing an embodiment of the respective functions 12, 56, 64 and/or 70, for example. Thus, the flow chart of FIG. 5 may be thought of as depicting steps of a method carried out by one or more of the mobile telephone 10, the server 54, the server 60 and the terminal 62. Although FIG. 5 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow may begin in block 84 where the mobile telephone 10 is placed in a transaction mode. The transaction mode may be commenced by making an appropriate menu selection using, for example, a graphical user interface. In one embodiment, entry into the transaction mode may be predicated on entry of valid authentication data, such as a personal identification number (PIN) or a voice sample that uniquely identifies the user. In one embodiment, it may be assumed that the user and the mobile telephone 10 are in relatively close proximity to the terminal 62 with which the user desires to make a transaction. For instance, the user may wish to withdraw cash from an ATM that functions as the terminal 62, may wish to purchase something from a vending machine that functions as the terminal 62 or purchase something from a store where a cash register functions as a terminal 62. In these embodiments, the user may be located in the presence of the terminal 62 or the user may be in transit to the terminal 62.

The logical flow may proceed to block 86 to initiate a process for identifying the location of the mobile telephone 10. For instance, a request for location identification assistance using AGPS may be transmitted to the server 54. In response to the request, the server 52 may identify or assist in identifying the location of the mobile telephone in block 88. Once identified, the location of the mobile telephone 10 may be transmitted from the server 52 to the mobile telephone 10 in block 90 and the location data (e.g., location coordinates) may be received by the mobile telephone 10 in block 92. It will be appreciated, that other techniques for identifying the location of the mobile telephone 10 may be used instead of or in addition to AGPS.

In block 94, a transaction request may be transmitted from the mobile telephone 10 to the transaction network server 60. It will be appreciated that communication between the mobile telephone 10 and the server 60 may be directed through the communications network 52, including the server 54. In one embodiment, such communications may be encrypted.

The request may include the location data (e.g., coordinates) that were identified in block 86. In this manner, the location of the mobile telephone 10 with respect to one or more terminals 60 may become known to the server 60. It will be appreciated that the logical flow may be modified such that the location data for the mobile telephone 10 may be transmitted from the server 54 to the server 60, rather than as part of the transaction request of block 94.

The transaction request may further include various parameters associated with the requested transaction. The user may enter the parameters using a menu and/or graphical interface of the mobile telephone 10. For instance, if the transaction is a withdrawal of cash from an ATM, the parameters may indicate the amount to be withdrawn, the account from which to withdraw the funds if there is more than one possibility, whether the user desires a receipt, and so forth. If the transaction relates to the purchase of an item, the parameters may indicate a credit account to apply the purchase against or a debit account from which the funds are to be withdrawn, whether the user desires a receipt, and so forth. In some embodiment, the purchase transaction parameters may specify the specific goods or services to be supplied. In another embodiment, some or all of the transaction parameters may be specified by interaction with the terminal 62 instead of with the mobile telephone 10.

The request may be received by the server 60 in block 96 and processed in block 98. The processing may include, for example, approving the transaction. For instance, the server 60 may determine if the user has sufficient funds in his or her account to fund the transaction or sufficient credit to charge the transaction against.

Processing the request may include determining which terminal 62 (or terminals) in the transaction network 58 that has a physical (e.g., location-based) relationship to the location of the mobile telephone 10. In one embodiment, the server 60 may identify the terminal(s) 62 that can satisfy the type of requested transaction and that is located within a predetermined distance from the mobile telephone 10 or within a distance specified by the user of the mobile telephone 10. The predetermined distance may be one of a mile, a half mile, a quarter mile, 100 yards, 100 feet or 50 feet from the location of the mobile telephone 10 as identified in block 86, to name a few examples. In another embodiment, the terminals 62 that have a relationship to the mobile telephone 10 may depend on a situational context. For instance, if the mobile telephone 10 is determined to be at a shopping mall or other shopping area, the terminals that have a relationship to the mobile telephone 10 also may be located at the same shopping mall or area. In other embodiments, one or more terminals may be specified by the user, such as by identifying a selected terminal(s) 62 as part of the transaction request in block 94. In this embodiment, the mobile telephone 10 need not be within a predetermined distance of the specified terminal 62 at the time that the transaction request is made so as to accommodate a situation where the user is planning to travel to the location of the user selected terminal 62. Also, the location of the mobile telephone 10 may be dynamically updated and the terminal(s) 62 that have a location-based relationship with the mobile telephone 10 may be updated in accordance with movement of the mobile telephone 10.

The logical flow may proceed to block 100 where the server 60 transmits transaction parameters to the terminal(s) 62 that was identified as having a location-based relationship to the mobile telephone 10. The server 60 may also transmit data that may uniquely identify the mobile telephone 10, such as a communications network 52 subscriber identity or an RFID tag code that is associated with the mobile telephone 10.

In addition, the server 60 may transmit a transaction code to the terminal 62. The transaction code may be a code (e.g., string of alphanumeric characters) that is needed by the mobile telephone 10 for the requested transaction to be completed. In one embodiment, the transaction code may be unique to the transaction. In addition, the transaction code may have an expiration after which the transaction code is no longer valid. The transmission of block 100 may include any other data concerning the requested transaction that may be of use to the terminal 62 during a subsequent interaction with the mobile telephone 10.

In block 102, the data transmitted by the server 100 may be received by the terminal(s) 62 that was identified as having a relationship to the mobile telephone 10. In some circumstances, the data may be transmitted to only one terminal 62. This may occur when only one terminal 62 meets the criteria for carrying out the transaction. In circumstances when plural terminals 62 meet the criteria for carrying out the transaction, the data may be transmitted to more than one terminal 62. The presence of plural terminals 62 that meet the criteria for carrying out the transaction may occur in a number of situations, examples of which include the presence of two or more ATMs or the presence of two or more cash registers at a “check-out” area of a store. The transmission of the data to more than one terminal 62 may expedite the transaction when there are plural possible terminals 62 to carry out the transaction. In these circumstances, it is contemplated that the user may approach any one of the terminals 62 to complete the transaction. Regardless of the number of terminals 62 to which the data is transmitted in block 100 and received in block 102, each terminal 62 that is in receipt of the data may interface with the mobile telephone 10 to complete the transaction as described below.

In block 104, the server 60 may transmit the transaction code to the mobile telephone 10 in block 104. The transaction code may be received by the mobile telephone 10 in block 106. The transmission of block 104 may include any other data concerning the requested transaction that may be of use to the mobile telephone 10 during a subsequent interaction with the terminal 62.

Thereafter, the user may bring the mobile telephone 10 into relatively close proximity with the terminal 62 and, in blocks 108 and 110, a communication between the mobile telephone 10 and the terminal 62 may be established. In one embodiment, the communication may be established over a localized communication link using the respective localized communicators 48 and 78. In another embodiment, the communication may be established over a wireless communication link using the respective local wireless interfaces 46 and 76. In another embodiment, communication using the localized communicators 48 and 78 may initiate communications using the wireless interfaces 46 and 76.

In block 112, the mobile telephone 10 may transmit the transaction code to the terminal 62 over the communications link that is established in blocks 108 and 110. Any other data relevant to processing of the transaction by the terminal 62 also may be transmitted. The data transmitted by the mobile telephone 10 may be received by the terminal in block 114. Following receipt of data from the mobile telephone 10, the terminal 62 may process the transaction in block 116.

With additional reference to FIG. 6, illustrated are exemplary logical operations that may be carried out by the terminal 62 to process the transaction. Although FIG. 6 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for processing the transaction (block 116 of FIG. 5) may begin in block 118 where a determination is made as to whether the transaction code received by the terminal 62 from the mobile telephone 10 in block 114 matches the transaction code received by the terminal 62 from the server 60 in block 102. If the transaction codes do not match, the logical flow may end. If the transaction codes match, the logical flow may proceed to block 120.

In block 120, a determination is made as to whether the transaction code 120 has expired. As indicated, the transaction code may be valid for a predetermined duration, such as five minutes, ten minutes, fifteen minutes, thirty minutes, one hour or two hours, to name a few examples. If the time that has elapsed since receiving the transaction code in block 102 is greater than the predetermined duration associated with the transaction code, then the transaction code may be considered to have expired. If the transaction code has expired, the logical flow may end. If the transaction code has not expired, the logical flow may proceed to block 122.

In block 122, a determination is made as to whether additional authentication should be obtained from the user of the mobile telephone 10 prior to completion of the transaction. If no additional authentication is to be obtained, the logical flow may proceed to block 124, which is described below. If addition authentication is to be obtained, the logical flow may proceed to block 126. In block 126, the additional authentication may be requested from the user. The additional authentication may take one or more forms including, for example, entering of an alphanumeric code (e.g., a PIN), entering of a voice sample, entering of writing sample, reading of a fingerprint, or scanning of a retina, etc. In block 128, data relating to the authentication may be received by the terminal 62. If the requested authentication data is the entry of alphanumeric characters, the entry may be made by using the keypad 18 of the mobile telephone 10 or the input device 72 of the terminal 62. Similarly, if the requested authentication data is the entry of a voice sample, the entry may be made by speaking into the microphone 32 of the mobile telephone 10 or a microphone of the terminal 62. If appropriate, the terminal 62 may include a fingerprint scanner, a retinal scanner or any other sensor or input device for receiving or entering of authentication information.

In block 130, a determination is made as to whether the authentication data is valid. For instance, the authentication data received in block 128 may be compared against a previously obtained sample of the authentication data. If the authentication data is not valid, the logical flow may end. If the authentication data is valid, the logical flow may proceed to block 124. In another embodiment, the authentication data may be collected for inclusion with the transaction request of block 94 and validated by the server 60 as part of processing the request in block 98.

In block 124, the terminal 62 may carry out steps to finalize the transaction. For instance, if the transaction is the withdrawal of cash or a cash advance, the terminal 62 may dispense an appropriate amount of money and a receipt. If the transaction is the sale of an item from a vending machine, the appropriate item may be dispensed. If the transaction is a cash register transaction, a receipt may be printed. Also, any anti-theft security tags attached to merchandise associated with the transaction may be deactivated. In addition, the terminal 62 may acknowledge completion of the transaction to the server 60. The server 60, in turn, may debit or charge an appropriate account of the user. Also, the server 60 may cancel the transaction code by transmitting a transaction code cancellation message to the terminal(s) 62 to which the transaction code was transmitted in block 100.

As will be appreciated, the methods described herein may speed transactions. For instance, the interaction time at an ATM, cash register or vending machine may be reduced compared to conventional approaches since information relating to the transaction may already be processed by the transaction network 50. Also, security may be enhanced. For instance, for the transaction to be completed, a transaction code having a limited life-span and having limited distribution is used to authenticate the presence of the mobile telephone 10 with respect to the terminal 62. In addition, the transaction code is valid in a limited area surrounding the user. In addition, these methods decrease the need for the user to carry items such as banking cards, credit or debit cards, smart cards and so forth.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of conducting a transaction, comprising:
determining a location of a mobile electronic device;
identifying at least one transaction terminal that has a location-based relationship with the mobile electronic device; and
providing a transaction code to the identified transaction terminal and the mobile electronic device, the transaction code for authenticating the mobile electronic device during interaction of the mobile electronic device and the transaction terminal.

2. The method of claim 1, wherein the transaction code is valid for a limited duration.

3. The method of claim 2, wherein the transaction code is valid for a single transaction.

4. The method of claim 1, wherein the transaction code is valid for a single transaction.

5. The method of claim 1, wherein location data for the mobile electronic device is supplied by one of the mobile electronic device or a communications network that supplies communications services to the mobile electronic device.

6. The method of claim 1, wherein the identified transaction terminal is within a predetermined distance from the location of the mobile electronic.

7. The method of claim 1, wherein the identified transaction terminal is selected by a user of the mobile electronic device.

8. The method of claim 1, further comprising receiving a transaction parameter from the mobile electronic device and authorizing the transaction.

9. The method of claim 8, further comprising transmitting the transaction parameter to the transaction terminal.

10. The method of claim 1, wherein the transaction is a withdrawal of money from a bank account or a cash advance.

11. The method of claim 10, wherein the transaction terminal is an automated teller machine.

12. The method of claim 1, wherein the transaction is the purchase of at least one of goods or services.

13. The method of claim 12, wherein the transaction terminal is a vending machine.

14. The method of claim 12, wherein the transaction terminal is a cash register.

15. A method of conducting a transaction, comprising:
transmitting a transaction request from a mobile electronic device to a transaction server;
receiving a transaction code from the transaction server with the mobile electronic device, the transaction code for authenticating the mobile electronic device during interaction of the mobile electronic device and a transaction terminal;
establishing a communication link between the mobile electronic device and the transaction terminal; and
transmitting the transaction code to the transaction terminal.

16. The method of claim 15, wherein the transaction code is valid for a limited duration.

17. The method of claim 15, wherein the transaction code is valid for a single transaction.

18. The method of claim 15, further comprising providing a location of the mobile electronic device to the transaction server.

19. The method of claim 15, further comprising transmitting a transaction parameter to the transaction server.

20. A method of conducting a transaction, comprising:
receiving a transaction code from a transaction server with a transaction terminal, the transaction code for authenticating a mobile electronic device during interaction of the mobile electronic device and the transaction terminal;
establishing a communication link between the transaction terminal and the mobile electronic device;
receiving a transaction code from the mobile electronic device; and
verifying that the transaction code from the mobile electronic device matches the transaction code from the transaction server.

21. The method of claim 20, wherein the transaction codes are valid for a limited duration and the method further includes verifying that the transaction codes have not expired.

22. The method of claim 20, wherein the transaction codes are valid for a single transaction.

23. The method of claim 20, further comprising requesting additional authentication from the user of the mobile electronic device.
